(19) United States
(12) Patent Application Publication
(10) Pub. No.: US 2007/0042656 A1
(43) Pub. Date: Feb. 22, 2007

(54) Multicolored mat and manufacturing method thereof

(76) Inventor: Hsu Tang Su-Tuan, Tao Yuan City (TW)

Correspondence Address: TROXELL LAW OFFICE PLLC;SUITE 1404, 5205 LEESBURG PIKE, FALLS CHURCH, VA, 22041, US

(21) Appl. No.: 11/205,091

(22) Filed: Aug. 17, 2005

(51) Int. Cl. B32B 27/04; B05D 7/00; B05D 3/02

(52) U.S. Cl. 442/43; 442/58; 427/372.2; 427/421.1

(57) ABSTRACT

A multicolored mat and manufacturing method thereof are disclosed. The present method includes the following steps: (a) providing, flattening and conveying a piece of meshed cloth; (b) coating the flattened cloth with several flexible high polymers having different colors contained in a plurality of containers according to at least one predetermined pattern; and (c) heating the flattened cloth coated with flexible high polymers at a predetermined high temperature so as to foam the flexible high polymers.

### BACKGROUND OF THE INVENTION

1. Field of the Invention

The present invention relates to a multicolored mat and manufacturing method thereof, and more particularly, to a multi-functional multicolored mat and manufacturing method thereof.

2. Description of the Prior Art

The method for manufacturing single-colored PVC mats has been disclosed in Taiwanese Patent No. 119039, entitled “METHOD FOR FORMING ANTI-SLIDE PAD HAVING ENVIRONMENTAL PROTECTION FUNCTION AND ANTI-SLIDE PAD BASED ON THEREOF. As disclosed in the method, a substrate is immersed in a coating material and heated to foam so as to manufacture an anti-slide mat having vacuum suction. Although the technology for manufacturing single-colored PVC mats is mature, it is still difficult to manufacture dual-colored mats because high-temperature and foaming are required during the manufacturing process. In addition, it is difficult to meet the requirements of flexibility, uniform thickness and delicacy at the same time.

### SUMMARY OF THE INVENTION

The present invention provides a multicolored mat and manufacturing method thereof. The present invention is able to coat a piece of meshed cloth with at least two polyvinyl chloride materials having different colors, and achieve distinct color boundary and uniform thickness.

In the present invention, the polyvinyl chloride materials can be formed on two different surfaces so as to achieve diversity.

The present multicolored mat includes a piece of meshed cloth having an upper surface and a lower surface, and a plurality of color blocks formed according to determined patterns located on at least one of the two surfaces. The plurality of color blocks are formed by foamed or inflated flexible high polymer materials having different colors.

The present invention provides a method for manufacturing a multicolored mat, includes the steps:

(a) providing, flattening and conveying a piece of meshed cloth; (b) coating the flattened meshed cloth with flexible high polymers having different colors, contained in a plurality of containers located on at least one side of the meshed cloth according to a predetermined pattern; and (c) heating the flattened meshed cloth coated with flexible high polymers at a predetermined high temperature so as to foam the flexible high polymers.

### BRIEF DESCRIPTION OF THE DRAWINGS

The foregoing aspects and many of the attendant advantages of this invention will become more readily appreciated and better understood by referencing the following detailed description, when taken in conjunction with the accompanying, wherein:

FIG. 1 illustrates the perspective view of the present natural polymer mat according to the present invention;

FIG. 2 illustrates the method of forming the present natural polymer mat according to the first embodiment of the present invention; and

FIG. 3 illustrates the method of forming the present natural polymer mat according to the second embodiment of the present invention.

### DESCRIPTION OF THE PREFERRED EMBODIMENT

The present method provides a multicolored multi-functional mat, which uses meshed cloth as a support. The present mat is coated with different PVC (polyvinyl chloride) materials located on different areas of the surface so that the present mat presents at least two colors.

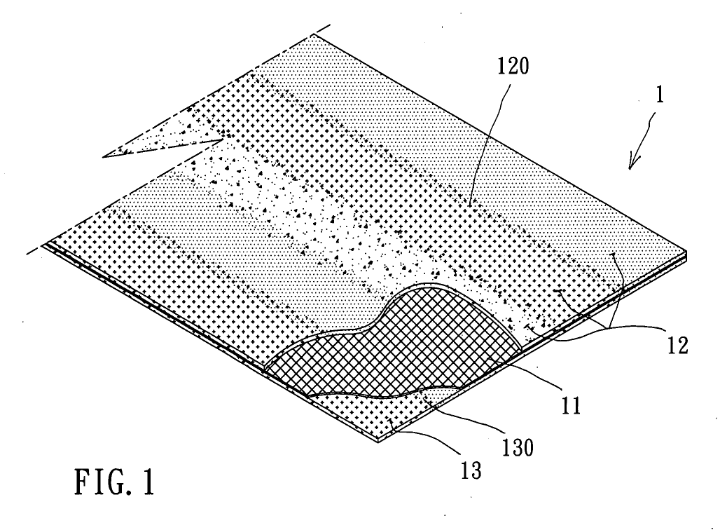

Please refer to FIG. 1, which depicts the perspective view of the present multicolored mat. The present multicolored mat includes a piece of meshed cloth 11 having an upper surface and a lower surface, and a plurality of color blocks 12 or 12, 13 formed by determined patterns located on at least one of the two surfaces. In the preferred embodiment, the color blocks 12, 13 are located on both the upper and lower surfaces of the meshed cloth 11, and the color blocks 12, 13 are formed by predetermined patterns, identical or different with each other. Among these, the color blocks 12, 13 are formed by mixing and foaming flexible high polymers having different colors, such as PVC. Because the flexible high polymers are provided in different locations of the meshed cloth 11, there is a distinct boundary 120 or 130 between the color blocks 12, 13. On the other hand, the predetermined patterns can be geometric patterns, characters or prints. In the preferred embodiment, the predetermined patterns are a plurality of parallel stripes.

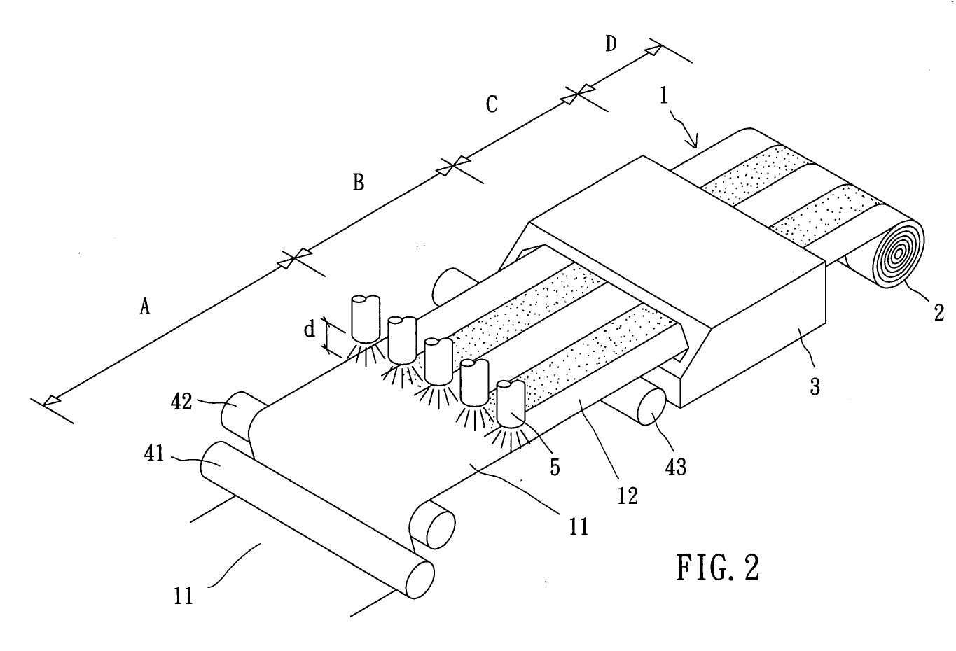

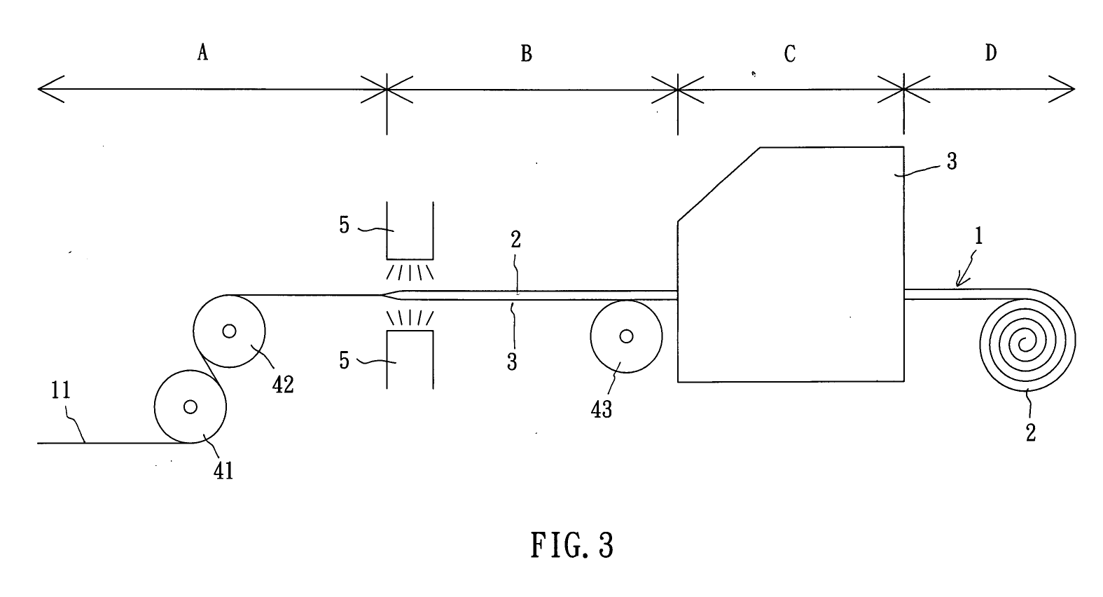

Please refer to FIG. 2 and FIG. 3, which depict two embodiments of the present method for manufacturing a multicolored mat. The present method is described in detail as follows. (a) A first roller 41 and a second 42 are provided and arranged on different levels. The meshed cloth 1 1 passes through the region between the first roller 41 and the second 42. The meshed cloth 11 leans against the first roller 41 and the second 42. The meshed cloth is conveyed to the area A and flattened by the first roller 41 and the second 42. (b) When the meshed cloth 11 is conveyed to the area B, a plurality of containers 5 containing high polymers with different colors, located on at least one side of the meshed cloth 11, sprays flexible high polymers, such as PVC, on the flattened meshed cloth 11. There is a distance d between the containers 5 and the meshed cloth 11. The containers 5 sprays the high polymers in a pre-determined rate so as to provide proper amount and control the thickness of the high polymers after foamed. As shown in FIG. 2, the container 5 are located the one side of the meshed cloth 11. As shown in FIG. 3, the container 5 are located on the different sides of the meshed cloth 11. (c) When the meshed cloth 11 is conveyed to the area C, the meshed cloth 11 coated with the flexible high polymers is heated at a pre-determined high temperature by an oven 3 so as to foam or inflate the flexible high polymers. A third roller 43 in front of the oven 3 is provided to support and convey the meshed cloth 11 coated with the flexible high polymers. (d) Once the flexible high polymers are foamed, the meshed cloth 11 is conveyed to area D and thus a multicolored mat is finished. The multicolored mat is rolled up to form a rolled multicolored mat 2.

On the other hand, the predetermined patterns can be formed by a variety of arrangements of the plurality of containers 5. Alternatively, the plurality of containers 5 can be driven by a stepping motor (not shown) to dynamically spray the predetermined patterns. The plurality of containers 5 can be arranged in the following manners, including: (i) the plurality of containers 5 are arranged in a line vertical to the conveyance direction of the meshed cloth 11 so as to form the predetermined patterns having a plurality of parallel stripes; (ii) the plurality of containers 5 are arranged in different distances so as to form the predetermined patterns having a plurality of parallel stripes separated from each other in different distances; (iii) the plurality of containers 5 are arranged in the same distance so as to form the the predetermined patterns having a plurality of parallel stripes separated from each other in the same distance; and (iv). there is a motor provided to drive the plurality of containers 5 to finish the predetermined patterns.

That is, the advantages of the present mat include:

1. The multicolored mat has distinct color blocks because the polyvinyl chloride materials having different colors are coated in different region of the surface of the multicolored mat. Meanwhile, the thickness of the foamed polyvinyl chloride materials is uniform because the amount of polyvinyl chloride materials coated on the meshed cloth, the conveyance speed and the heating temperature are properly controlled.

2. The polyvinyl chloride materials having different colors can be formed on different surfaces of the meshed cloth so that diversity of the multicolored mat is achieved.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A multicolored mat, comprising:
meshed cloth, having an upper surface and a lower surface; and
a plurality of color blocks, formed according to a predetermined pattern on one of the upper surface and the lower surface;
wherein the plurality of color blocks are formed by flexible high polymers having different colors.

2. The multicolored mat according to claim 1, wherein the flexible high polymers is polyvinyl chloride.

3. The multicolored mat according to claim 1, further comprises a distinct boundary between the plurality of color blocks.

4. The multicolored mat according to claim 1, wherein the predetermined pattern is chosen from the group consisting of a stripe, a geometric pattern, characters or a print.

5. The multicolored mat according to claim 1, wherein the plurality of color blocks are two same patterns or two different patterns, and are formed on the upper surface and the lower surface.

6. A method for manufacturing a multicolored mat, comprising the steps as follows:
providing, flattening and conveying a piece of meshed cloth;
coating the flattened meshed cloth with flexible high polymers having different colors, contained in a plurality of containers located on at least one side of the meshed cloth according to a predetermined pattern; and
heating the flattened meshed cloth coated with flexible high polymers at a predetermined high temperature so as to foam the flexible high polymers.

7. The method according to claim 6, wherein the step of flattening further comprises the steps of:
providing two rollers, located on different levels;
conveying the meshed cloth through a region between the two rollers, leaning against the meshed cloth so as to flatten the meshed cloth.

8. The method according to claim 6, wherein the flexible high polymers comprises polyvinyl chloride materials having different colors.

9. The method according to claim 6, wherein there is a predetermined distance between the meshed cloth and the plurality of containers, and the plurality of containers spray the flexible high polymers in a predetermined rate so as to provide proper amount of the flexible high polymers.

10. The method according to claim 6, wherein the plurality of containers can be located on the same side or different side of the meshed cloth.

11. The method according to claim 6, wherein the plurality of containers are arranged in a line vertical to a conveyance direction of the meshed cloth so as to form the predetermined pattern having a plurality of parallel stripes.

12. The method according to claim 6, wherein the plurality of containers are arranged in different distances so as to form the predetermined pattern having a plurality of parallel stripes separated with each other in different distances.

13. The method according to claim 6, wherein the plurality of containers are arranged in the same distance so as to form the predetermined pattern having a plurality of parallel stripes separated with each other in the same distance.

14. The method according to claim 6, wherein the step of coating further comprises the step of:
providing the plurality of containers and a motor for driving the plurality of containers according to the predetermined pattern so as to finish the multicolored mat.

15. The method according to claim 6, wherein after the step of foaming the flexible high polymers further comprises the steps of:
rolling up the foamed multicolored mat.
